(19) United States
(12) Patent Application Publication
(10) Pub. No.: US 2003/0203173 A1
(43) Pub. Date: Oct. 30, 2003

(54) Artifact with transparent and protective anti-iridescent surface layer and finishing method therefor

(75) Inventors: Thomas Friesen, Verbania (IT); Gabriele Possenti, Pordenone (IT)

Correspondence Address: John S. Egbert, Harrison & Egbert, 412 Main Street, 7th Floor, Houston, TX, 77002, US

(73) Assignees: PLASTAL SPA, Pordenone (IT); ANTEC FINITURE SRL, Verbania (IT)

(21) Appl. No.: 10/426,752

(22) Filed: Apr. 30, 2003

(30) Foreign Application Priority Data
Apr. 30, 2002 (IT) TV2002A000051

(51) Int. Cl. B32B 3/00

(52) U.S. Cl. 428/209

(57) ABSTRACT

An artifact with anti-iridescent transparent and protective surface layer and related finishing method comprising: (a) readying an artifact that may be plastic, metallic, or plastic with metallic coating, obtained by vacuum deposition or galvanic technique; (b) executing, in correspondence with at least a superficial portion of the plastic, metallic, or plastic with metallic coating artifact, by means of vacuum deposition technique, of a superficial coating with a transparent film; and (c) the execution, in correspondence with the micro-morphology of the transparent coating—air interface, of a modification of the surface, so that it is not consistent with the micro-morphology of the substrate-coating interface.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to an artifact with transparent and protective anti-iridescent surface layer and method for conferring the anti-iridescence function to the transparent and protective surface layer of an artifact.

### BACKGROUND OF THE INVENTION

The innovation finds particular but not exclusive application in the sector of components made of plastic material with a metallic appearance such as for the exterior and interior of a car, but also for health care artifacts and accessories, home furnishing artifacts, fashion artifacts and accessories, such as appliances, cell phones and wherever it is necessary to apply a transparent protection with high resistance to wear, corrosion and dirt.

It is equally achievable for surfaces of supports of various kinds, hence not only metallized plastic (obtained by means of galvanization or vacuum metallization), but also plastic supports (painted, polymethylmetacrilate, polycarbonate or others) as well as metal supports (aluminum, magnesium, zinc, brass, bronze and nickel), and lastly to galvanically treated metals.

It has been noted, for instance, that one of the possible applications mentioned above pertains to plastic components for motor vehicle interiors. Usually, the passenger compartment is particularly pleasant and attractive, and in addition to the seats coated with synthetic material or leather in a multitude of hues, it is also provided with upholstery, aimed at coating, essentially, part of the doors, of ceiling and of the bottom.

Also present is a dashboard which, in general terms, comprises the instrument panel, provided with the driving instruments, the switches that activate the operation of various accessories, the ventilation outlets and other items. Said dashboard, moreover, in a central position, is usually joined by a so-called tunnel, developed towards the rear, which comprises the gear lever and hand brake assembly and serves as a baffle to separate the driver's side from the passenger side. For most cars marketed today, in all market segments, it can be stated that both the tunnel and the dashboard are almost completely obtained from the molding of plastic material, not excluding those particularly visible parts, which for instance can be located in the instrument panel and in otherwise in the front, most visible part of the passenger compartment.

These parts, such as the covers located in proximity to the door handles, or even the ashtray door, or more simple used to furnish the surface surrounding push-button controls for opening the windows or the sunroof, until a short time ago had a plain appearance with uniform color, mostly tending to gray or black.

The continuous advancements, aimed at identifying ever more attractive esthetics, first suggested the use of different materials, to be combined with the basic plastic material, such as wooden profiles. Then, for cost reasons, use has been made of profiles and inserts of various kinds with a wooden appearance, which as such, were constituted by a support made of plastic material treated superficially, for instance finished with briar appearance by means of cubic technique. Said work processes, however, are poorly suited to the multitude of innovative products required by companies, which need a broader range of finishing options, achievable at competitive costs and at the same time able to confer a particular and always different esthetic value to be refined as fashions continually change.

Currently, in the manufacture of said esthetic components, polymeric alloys are commonly used, for instance an alloy of ABS-PC, originating artifacts, which are subsequently subjected to a finishing method. Said method, if surfaces with metallic effect are to be obtained, requires the application, by means of galvanic technique, of layers in logical succession of metallic materials, which, by depositing on the surface of the artifact, confer a particular combination of color and gloss. This finishing method, known as plastic metallization, in use since the Sixties has been particularly appreciated, and even today is widely used, above all because of the ability to combine the characteristics of the plastic substrate (light weight, tenacity and flexibility, ease of manufacture of complex shapes, excellent quality of the surface as such after molding) with the property of the metallic finishing (extremely shiny appearance, hygienic surface, abrasion resistant surface, good resistance to corrosion).

Yet more in particular, a traditional metallization method requires in logic succession the execution of the following steps:

(a) injection molding of the artifact;

(b) chemical metallization of the molded piece;

(c), (d) and (e) galvanization in multiple stages by subsequent deposition, by layers of at least a first and a second metal having a different electrochemical potential;

(f) activation of said second metal, for instance with a caustic soda based solution;

(g) galvanic application of a layer of an alloy composed of nickel and tin;

(h) heat treatment for the elimination of residual metallic stresses in the mass of polymeric mass;

(i) and (j) application of at least one layer of protective paint.

The above solution has some drawbacks, which substantially can be ascribed to the fact that said work process entails problems linked with insufficient resistance, over time, to wear and to atmospheric agents.

The Italian patent application no. ITPN96000067 (Plastal-Zop), aims at solving the drawbacks mentioned above, proposing a method for a superficial “metallization” finishing of an artifact, suitable to be mounted as a component on external surfaces of cars and motor vehicles, made of synthetic material, which comprises the following steps of:

chemical metallization of the plastic material;

galvanization with successive deposition of layers of at least to corrosion-proofing metals having different electrochemical potential;

galvanization with deposition of a chrome layer;

maintaining the artifact at ambient temperature, in any case no higher than 30° C., for a minimum time interval of about 24 hours;

removal of said layer of chrome;

activation of the outermost layer of corrosion-proofing metal;

application of the metallic layer able to provide the artifact with the desired esthetic finishing;

heat treatment for stress elimination; and

lacquering with at least a layer of transparent paint in order to protect the aforesaid esthetic finishing.

Lastly, another published document is proposal contained in ITTV2000A000144 (De Meis) which teaches a method for the superficial decoration of artifacts of plastic material, particularly for visible components of a motor vehicle, wherein a cycle for the manufacture of an artifact made of injection molded ABS/PC-Blends comprises the following steps:

(a) chemical metallization of the plastic material;

(b), (c), (d) galvanization with successive deposition of layers of at least two corrosion-proofing metals having different electrochemical potential;

(e) activation of the outermost layer of anti-corrosion metal;

(f) application of the metallic layer able to provide the artifact with the desired esthetic finishing;

(g) heat treatment for stress elimination; and

(h) vacuum deposition treatment of a superficial decorative layer, by PVD (Physical Vapor Deposition) technique.

Also known are the treatments made on the artifacts made of plastic materials, aimed at providing the surface layer with a protective function. Said transparent coatings, such as SiOx, Al₂O₃, TiO₂ and others, produced with vacuum technologies, for instance with PECVD (Plasma Enhanced Chemical Vapor Deposition) technologies, PVD (Physical Vapor Deposition), MOCVD (Metal Organic Chemical Vapor Deposition) and MOPECVD (Metal Organic Plasma Enhanced Chemical Vapor Deposition) and others, serve the purpose of improving resistance:

against scratches

against wear

against chemical corrosion (such as deriving from the use of detergents, alkaline and acid agents)

Yet in closer detail, there is not doubt that said transparent and protective coatings improve the characteristics of the finished product with respect to those of non coated materials. For example, there is a significant reduction in the visibility of fingerprints and greasy dirt and this is especially true on highly visible surfaces, such as glossy and shiny materials, such as chrome, bronze, brass and others. Yet another advantage deriving from the aforementioned coating techniques resides in the fact that it facilitates their cleaning and, in case of metallic surfaces, has the ability to maintain the cold effect when touched with respect to the same piece protected by painting.

Drawbacks

In spite of the described advantages of said type of transparent and protective coating, it is well known that, in the presence of light sources having a spectrum with highly accentuated frequency bands (such as those associated with the use of neon or mercury lamps), an undesired optical phenomenon of interference can be noted on the artifact.

This optical phenomenon, more properly known as iridescence, is characteristic of some minerals, and it generates superficial and occasionally mobile reflexes, with a series of lines, of the colors of the iris.

In the case at hand, it can be stated in the final analysis that iridescence is due to changes in the thickness of the transparent layer given by its non homogeneous vacuum deposition on the treated part.

The optical phenomenon thus identified, which indistinctly involves the entire area treated by the transparent coating, gives rise, in the persons who make use of it, to a significant alteration of the optical and tactile perception. It is unpleasant, suggesting in the person sensations which induce to deem the artifact to be cheap and of very poor quality.

On the other hand, it also true that the optical phenomenon can be easily solved by means of a painting technique, but it is evident that said solution certainly does not have the advantages of the aforementioned transparent coatings obtained by means of vacuum deposition of the protective layer.

State of the Art

Now, in some sectors, such as the sector of the manufacture of optical lenses, the problem of iridescence is solved by creating a multi-layer with each layer having different refraction index and thickness and with an odd number of layers, greater than two. Such is the case of EP0404463 (Wheatley et al.) which describes a reflecting polymeric body. More in detail, it is a reflecting multilayer body, comprising alternating layers of at least a first and second polymeric material, whose layers mostly have an optical thickness of no more than 0.90 μm or no less than 0.45 μm, and adjacent layers of said first and second polymeric materials whose refraction indexes differ by at least 0.03. A sufficient number of layers is present in order to prevent iridescent and usually 30 percent of non absorbed incident light is reflected. The reflecting body can be obtained in sheets, metallized non corrosive surfaces of items and parts, and reflecting lenses.

Others, such as U.S. Pat. No. 4,294,193 (Gordon) have the solved the iridescence problem by providing an apparatus that deposits a vaporized coating in correspondence with a planar glass plate, for windows, of a first infrared reflecting material whose thickness is advantageously less than 0.85μ and where the relief of the iridescence ascribable to the first coating is significantly reduced, providing a layer with continuous variation of the refraction index between the glass and the coating, so that the refraction index increases continuously from the glass to the first coating.

The solutions adopted heretofore, for instance in the field of lenses, are successful only if the artifact develops mainly on 2 dimensions. However, in most sectors, such as the sectors mentioned above, i.e. in all sectors where artifacts developed in 3 dimensions and more complex are treated, the problem is particularly present and unsolved.

Hence, the need for companies, particularly in this industry, to identify improvements to current finishing techniques for such components.

An aim of the present invention is also to overcome the drawbacks described above.

### BRIEF SUMMARY OF THE INVENTION

This and other aims are achieved with the present invention according to characteristics set out in the accompanying claims, solving the problems described above by means of an artifact with anti-iridescent transparent and protective surface layer and related finishing method comprising:

(a) readying an artifact that may be plastic, metallic, or plastic with metallic coating, obtained by vacuum deposition or galvanic technique;

(b) executing, in correspondence with at least a superficial portion of the plastic, metallic, or plastic with metallic coating artifact, by means of vacuum deposition technique, of a superficial coating with a transparent film; and

(c) the execution, in correspondence with the micro-morphology of the transparent coating—air interface, of a modification of the surface, so that it is not consistent with the micro-morphology of the substrate-coating interface.

Advantages

In this way, through the considerable creative contribution whose effect has allowed to achieve a considerable technical advance, several advantages are achieved.

First of all, an artifact treated with a low-thickness transparent protective coating is provided with the advantages of being non iridescent. Therefore, neither the optical nor the tactile perception of the artifact is altered, optimizing all characteristics of the transparent protective coating deposited with vacuum technique.

More in particular, it allows to obtain artifacts whose superficial finish is particularly hard and resistant to abrasion. This circumstance, in spite of the possible carelessness of the users of the artifact, facilitates the stable permanence of the original appearance over time, to the benefit of the consumer, who is thus able to appreciate the quality of the materials employed. In other respects, it simplifies the work process, with benefits in terms of cost and time.

A second, important advantage relates to the fact that such a treatment provides the artifact with a good chemical and corrosion resistance, which allows its use even in particularly unfavorable positions and conditions, where heretofore they could not be employed.

Yet further advantages consist of the safeguard of the esthetic peculiarities of the substrate, which may make use of broad range of hues achievable, with particular effects and with good color stability, under different environmental conditions, all solutions which allow simultaneously to satisfy and diversify multiple product lines.

These and other advantages shall become readily apparent from the detailed description that follows of a preferred embodiment, with the aid of the accompanying schematic drawings whose execution details are not to be construed as limiting but are only provided by way of examples.

### BRIEF DESCRIPTION OF THE SEVERAL VIEWS OF THE DRAWINGS

FIG. 1 shows the micro-morphology of a transparent coating applied to a substrate of the shiny treated kind.

FIG. 2 shows the micro-morphology of a transparent coating applied to a substrate of the glossy treated kind.

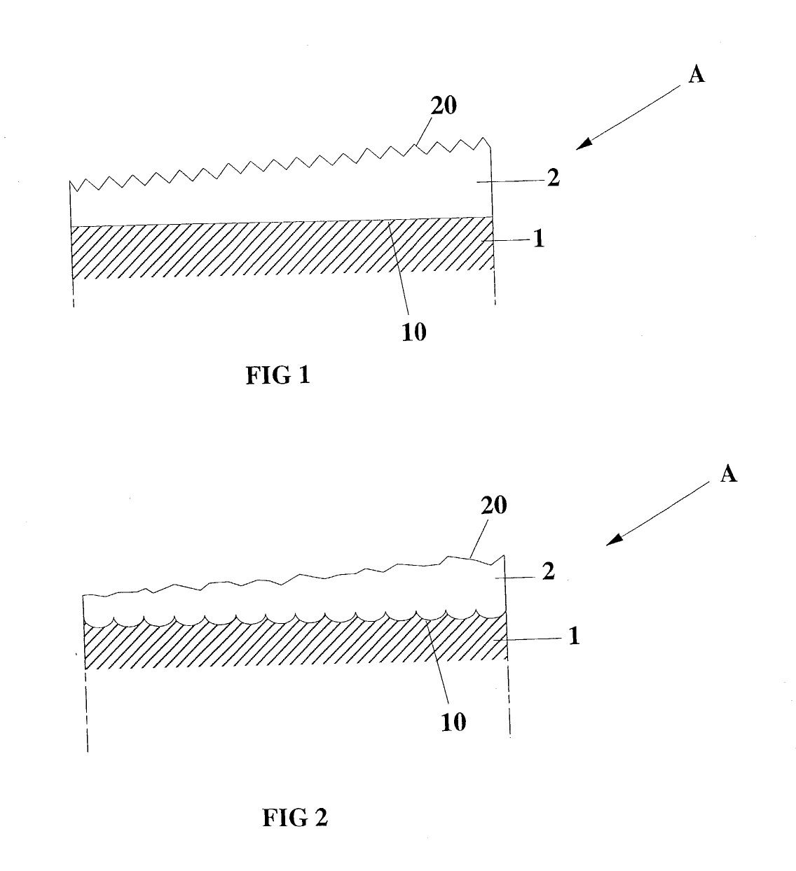

### DETAILED DESCRIPTION OF THE INVENTION

Given that the post-finish treatment can be achieved on surfaces of supports of various kinds, hence not only metallized plastic (obtained by means of galvanization or vacuum metallization), but also to plastic supports (painted, polymethylmetacrilate, polycarbonate and others) as well as metallic ones (such as aluminum, magnesium, Zinc-Aluminum-Magnesium Alloy, brass, bronze and nickel) and lastly also galvanically treated metals, the following is a description, provided purely by way of example, of one possible application. The innovative part of the present invention refers to the steps c) and d) of the description that follows: therefore, the steps a) and b) may vary according to the different kinds of surfaces and supports mentioned above.

Step a.

On a plastic support, for instance of the obtained beforehand in blank form by injection molding ABS/PC (Acrilonitrile-Butadiene-Styrene and polycarbonates), one or more coating sequences are completed, with vacuum deposition technique (i.e. a vacuum condition between mbar 10⁻⁴ and mbar 100), or galvanic deposition, of metallic material and with any morphology, be it shiny, glossy, scratched, brushed or sanded.

Said step, better known as chemical metallization of the plastic material requires the application of a first layer of metal, such as nickel, whose purpose is to make electrically conductive the surface in order to allow, at different times, the deposition of successive metallic layer, each with its own corrosion-proofing and scratch-proofing purposes.

The steps of depositing the successive layers of metals can, may instance, comprise a first corrosion proofing metal, constituted by a layer of copper, followed by a second layer with different electrochemical potential, such as columnar semi-shiny nickel. In a preferred solution, after the first layer of nickel can be applied a second layer of nickel, for instance shiny laminar.

The layer of nickel, or if applied the second layer of nickel, is then activated in order to allow a good adhesion of the subsequent metallic layer of an alloy, preferably composed of nickel-tin, which may be followed by a stress-relieving treatment.

The components are then subjected to a step of coating with a thin layer of metal 1 with VD (Vapor Deposition) technique. It requires the artifacts treated according to the previous steps to be introduced into an appropriate apparatus to allow the thin coating of each in a vacuum, according to the desired decoration. More in particular, inside the chamber of the apparatus, after obtaining a vacuum, vapors are generated which according to a mixture of gases, appropriately combined with nitrogen and methane, with the concurrence of appropriate metal pellets, allows the uniform deposition of the nitrides thus originated on each artifact present within said chamber.

Step b.

At this point an artifact has been obtained, constituted by a support, coated with a substrate 1. Over said substrate is then executed an additional coating with a transparent film 2 composed of metal oxides and/or silicon oxides, pure or impure, of hydrocarbons or mixed with each other. Said oxides can, for instance, be of silicon Si, titanium Ti, aluminum Al, magnesium Mg, zirconium Zr, niobium Nb, wolfram or tungsten W. The application of said coating with a transparent film 2 for instance, SiOx, Al₂O₃, TiO₂, is always performed by means of a vacuum deposition technique, where the term vacuum indicates a vacuum condition of between mbar 10⁻⁴ and mbar 100. Said technique may consist of the aforementioned technologies such as PECVD (Plasma Enhanced Chemical Vapor Deposition), PVD (Physical Vapor Deposition), MOCVD (Metal Organic Chemical Vapor Deposition) and MOPECVD (Metal Organic Plasma Enhanced Chemical Vapor Deposition) and others.

Step c.

The support thus obtained A is lastly subjected to post treatment for the purpose of eliminating the iridescence effect. More in detail, on the upper part 20 of the coating layer 2 with thickness between 10 μm and 1 μm, a modification is made to the surface so that the micro-morphology of the interface 10 between substrate and coating is difference from the micro-morphology of the coating-air interface 20.

This inconsistency between the two surfaces, coating-air interface 20 on one side and substrate-coating interface 10 on the other, is preferably obtained by executing a vacuum erosion process by etching with gas or gas mixtures. Good results have also been achieved with mechanical or chemical erosion techniques, the latter both liquid and dry.

In conclusion, it is thus possible to control the iridescence of the coating film, having the following characteristics:

thickness from 1 μm to 10 μm

transparency over 80%

refraction index from 1.4 to 2.9

We claim:

1. Artifact with transparent and protective superficial layer comprising a substrate, coated by means of vacuum deposition technique with a film of transparent material, characterized in that the micro-morphology of the transparent coating—air interface, is not consistent with the micro-morphology of the substrate-coating interface.

2. Artifact with transparent and protective superficial layer of the type obtained by means of vacuum deposition technique and composed of metal oxides and/or silicon oxides, pure or impure of hydrocarbons or mixed with each other, as claimed in claim 1, characterized in that the transparent and protective film has the following characteristics:
thickness from 1 μm to 10 μm
transparency over 80%
refraction index from 1.4 to 2.9

3. Method for conferring the anti-iridescence function to the transparent and protective superficial layer of an artifact as claimed in claims 1 and 2, comprising:
readying an artifact made of plastic, metal, or plastic with metallic coating obtained by vacuum deposition technique or galvanically;
the execution, in correspondence with at least a superficial portion of the artifact made of plastic, metal, or plastic with metallic coating, by vacuum deposition, of a superficial coating with a transparent film;
characterized in that the step subsequent to the deposition of a superficial coating with a transparent film requires the execution, in correspondence with the transparent coating—air interface, of a modification of the surface, so that the micro-morphology of the surface is not consistent with the micro-morphology of the substrate-coating interface.

4. Method for conferring the anti-iridescence function to the transparent and protective superficial layer of an artifact, as claimed in the previous claims, characterized in that the modification of the micro-morphology of the coating-air interface is obtained by means of:
the execution of an erosive process under vacuum by means of etching with gases or gas mixtures, or
mechanical erosion technique, or
chemical erosion, either liquid or dry.
